(19) United States
(12) Patent Application Publication
(10) Pub. No.: US 2011/0250010 A1
(43) Pub. Date: Oct. 13, 2011

(54) CABLE ASSEMBLY STRENGTHENING HEAD

(75) Inventors: BIN XU, Kunshan (CN); CHIN-TE LAI, New Taipei (TW)

(73) Assignee: HON HAI PRECISION INDUSTRY CO., LTD., New Taipei (TW)

(21) Appl. No.: 13/081,178

(22) Filed: Apr. 6, 2011

(30) Foreign Application Priority Data
Apr. 7, 2010 (CN) 201010140816.6

(51) Int. Cl. F16B 7/04; F16B 11/00

(52) U.S. Cl. 403/266

(57) ABSTRACT

A cable assembly (100) comprising a cable (200) having an end extending along a centerline, a strengthening head (1) having a passageway (15) extending along said centerline and receiving the end of the cable (200) therein, and an overcoat (3) covering said strengthening head (1). The strengthening head (1) comprises a first half (11) and a second half (13) separated from the first half (11) along a plane wherein said centerline lies.

### BACKGROUND OF THE INVENTION

1. Field of the Invention

The present invention relates to a cable assembly having a strengthening head for receiving a cable end.

2. Description of Related Art

Conventional strengthening head is a unitary head with the head integrally formed, the cable being inserted into the head and then over-molded with a plastic overcoat. However, it is difficult to insert a cable into the unitary head.

So there is a need to provide a cable assembly overcoming the above shortcoming

### SUMMARY OF THE INVENTION

An object of the present invention is to provide an cable assembly having a strengthening head easily assembled with a cable. The cable assembly comprises a cable having an end extending along a centerline, a strengthening head having a passageway extending along said centerline and receiving the end of the cable therein, and an overcoat covering said strengthening head. The strengthening head comprises a first half and a second half separated from the first half along a plane wherein said centerline lies.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view of a cable assembly according to an embodiment of the present invention;

FIG. 2 is another perspective view of the same cable assembly shown in FIG. 1;

FIG. 3 is a perspective view of the strengthening head of the cable assembly shown in FIG. 1;

FIG. 4 is a perspective view of the strengthening head in FIG. 3 with the first half strengthening head and the second half strengthening head separated; and

FIG. 5 is another perspective view of the separated first and second half strengthening heads shown in FIG. 4.

### DETAILED DESCRIPTION OF THE INVENTION

Reference will now be made to the drawing figures to describe the present invention in detail.

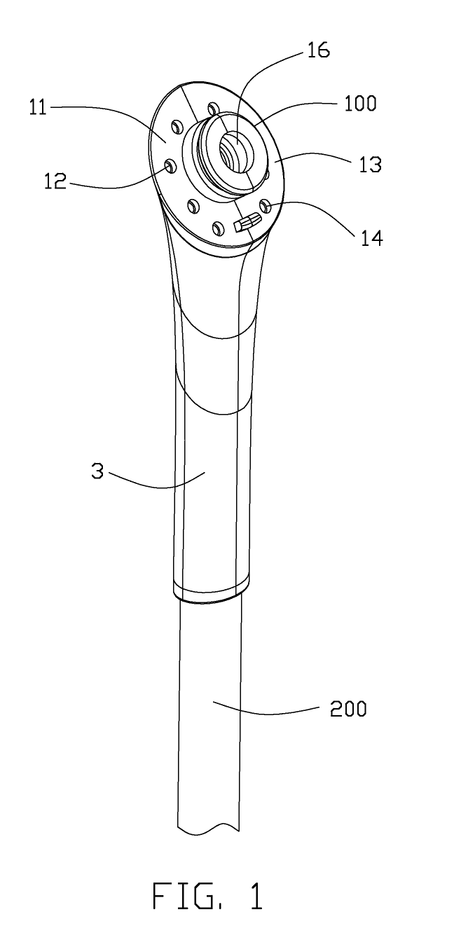

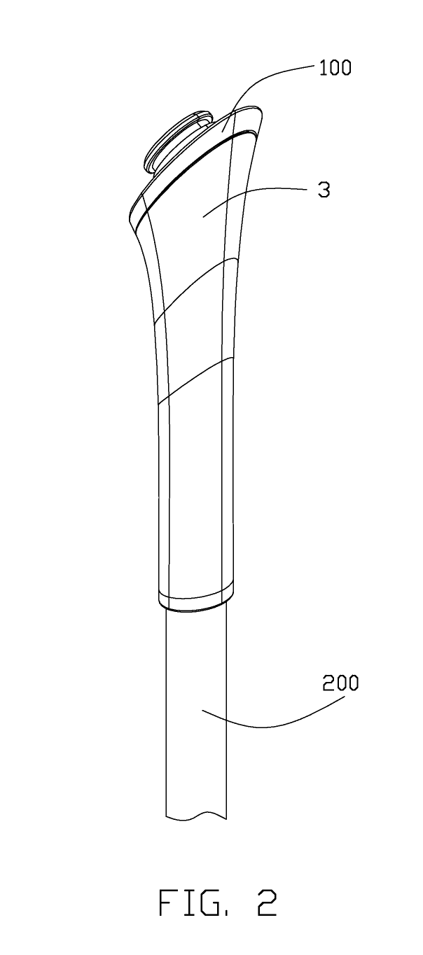

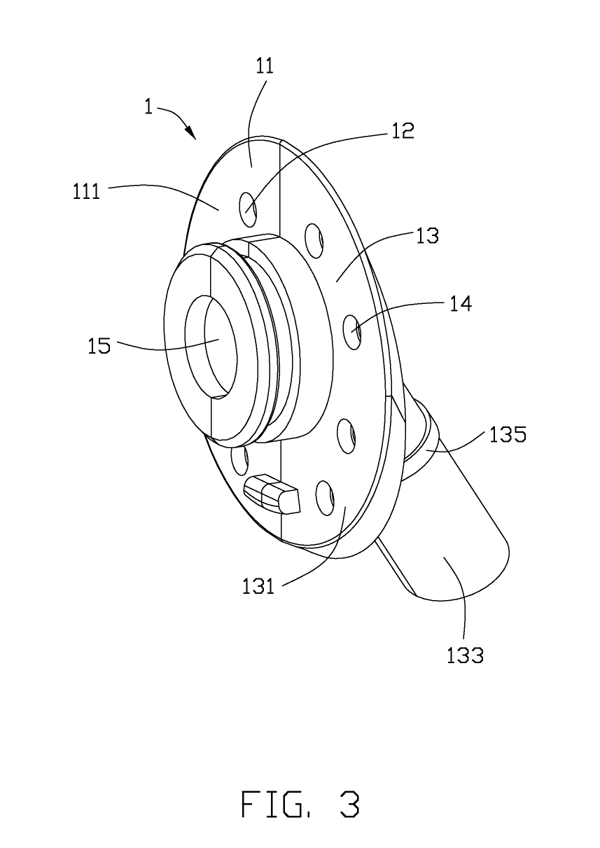

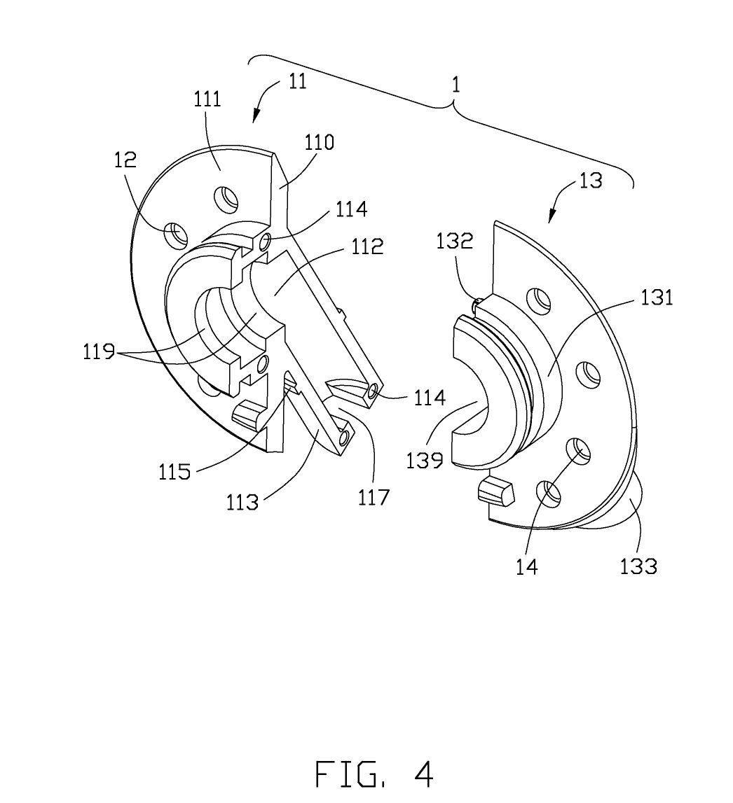

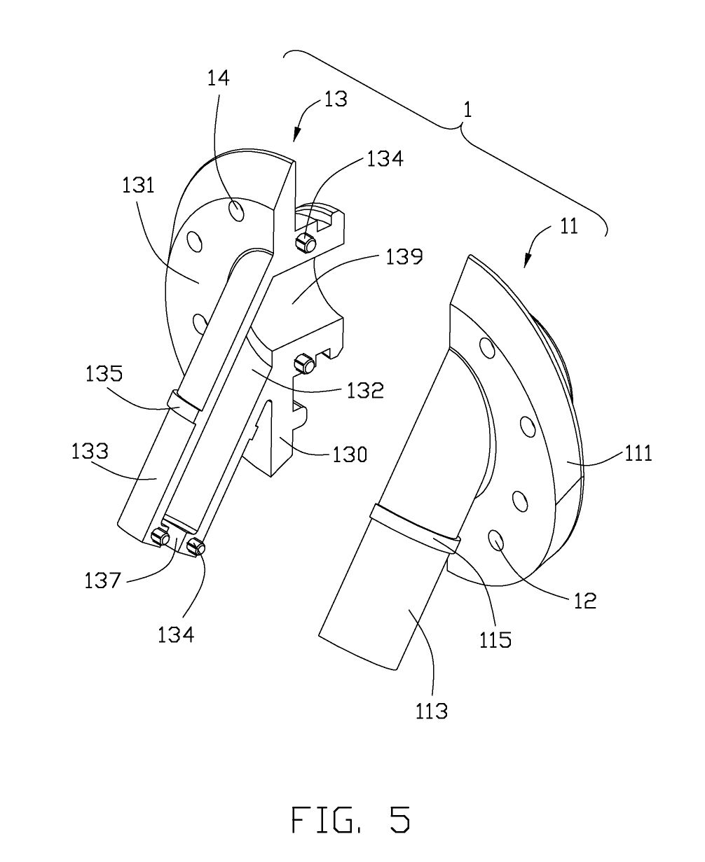

Referring to FIGS. 1-5, a cable assembly 100 according to an embodiment of present invention is shown. The cable assembly 100 comprises a cable 200 having an end and extending along its own axis or axial centerline, a strengthening head 1 having a passageway 15 extending along said centerline and receiving the end of the cable 200 therein, and a plastic overcoat 3 covering said strengthening head 1. The strengthening head 1 comprises a first half strengthening head 11 and a second half strengthening head 13 separated from the first half strengthening head 11 along a vertical plane wherein said centerline lies.

The first half strengthening head 11 has a separating face 110 and includes a plate portion 111 and a joining portion 113 extending from the plate portion 111. The second half strengthening head 13 has a separating face 130 and includes a plate portion 131 and a joining portion 133 extending from the plate portion 131. The first half strengthening head 11 defines a slot 112. The second half strengthening head 13 defines a slot 132. When the first half strengthening head 11 and the second half strengthening head 13 are assembled together, the two slots 112, 132 are combined into said passageway 15, with the first half plate portion 111 and the second half plate portion 131 combined to form a complete plate portion of the strengthening head 1, and the first half joining portion 113 and the second half joining portion 133 combined to form a complete joining portion of the strengthening head 1.

The complete joining portion has a respective rib 115, 135 extending along an outer surface of the complete joining portion. The complete joining portion is over-molded within the overcoat 3 and the ribs 115, 135 being molded within the overcoat 3. The complete plate portion defines a plurality of holes 12, 14. The overcoat 3 is formed with a plurality of fingers (not shown) extending into corresponding holes 12, 14 in a way known in this art. The slots 112, 132 of the first and the second half strengthening heads 11, 13 have narrowed portions 117, 119, 137, 139 in the passageway 15 for fastening or positioning the cable 200.

The disclosure is illustrative only, changes may be made in detail, especially in matter of shape, size, and arrangement of parts within the principles of the invention.

What is claimed is:

1. A cable assembly comprising:
a cable having an end extending along its own axis centerline;
a strengthening head having a passageway extending along said centerline and receiving the end of the cable therein; and
an overcoat covering said strengthening head;
wherein the strengthening head comprises a first half strengthening head and a second half strengthening head separated from the first half strengthening head along a plane wherein said centerline lies.

2. An cable assembly as claimed in claim 1, wherein each of the first half strengthening head and the second half strengthening head defines a slot extending along said centerline, the two slots combined into said passageway when the first half strengthening head and the second half strengthening head are assembled together.

3. An cable assembly as claimed in claim 2, wherein the strengthening head comprises a plate portion lies along a vertical plane and a joining portion extending along the centerline, the joining portion being over-molded within the overcoat.

4. An cable assembly as claimed in claim 3, wherein the joining portion has a rib extending along an outer surface of the joining portion around the centerline, the rib being molded within the overcoat.

5. An cable assembly as claimed in claim 4, wherein the plate portion defines a plurality of holes, the overcoat forming a plurality of fingers extending into corresponding holes.

6. An cable assembly as claimed in claim 5, wherein the slots of the first and the second half have narrowed portions in the passageway for positioning the cable.

7. A cable connector assembly comprising:
a cable defining an axial direction thereof;
a strengthening head defining a passage through which a front end portion of said cable extends, said strengthening head defining a front tubular section and a rear tubular section commonly sandwiching a disk like portion therebetween; and
an overcoat covering the rear tubular section and a back face of the disk like portion; wherein
the disk like portion essentially defines a plurality of through hole into which material of the overcoat invades for enhancing securement between the overcoat and the strengthening head.

8. The cable connector assembly as claimed in claim 7, wherein an axial direction of the front tubular section is perpendicular to the disk like portion while that of the rear tubular section is oblique to the disk like portion.

9. The cable connector assembly as claimed in claim 8, wherein the through hole of the disk like portion defines a corresponding axis parallel to the axial direction of the front tubular section while oblique to that of the rear tubular section.

10. The cable connector assembly as claimed in claim 8, wherein the rear tubular section further defines a rim structure for enhancing said securement between the overcoat and the strengthening head.

11. The cable connector assembly as claimed in claim 7, wherein said strengthening head is composed of two halves each with a semi-circular arrangement and symmetrically assembled to each other.

12. The cable connector assembly as claimed in claim 11, wherein interengaged hole-post structures are formed upon an interface between the two halves and define an engagement direction which is perpendicular to the axial direction of the cable.

13. A cable connector assembly comprising:
a cable defining an axial direction there along;
a strengthening head composed of two halves each being of a semi-circular arrangement and commonly defining a passage through which said cable extends;
an overcoat covering the strengthening head; wherein
each of said halves defines a first hole along a direction perpendicular to the axial direction of the cable for self-securement of the strengthening head, and a second hole along another direction parallel to the axial direction of the cable for enhancing securement between the strengthening head and the overcoat.
